(19) United States
(12) Patent Application Publication
(10) Pub. No.: US 2003/0130888 A1
(43) Pub. Date: Jul. 10, 2003

(54) Method and system for providing incentives to online fundraisers

(76) Inventor: Susan Daniher, Los Angeles, CA (US)

Correspondence Address: Micheal A. Rahman, Esq., Kintera, Inc., 9605 Scranton, Suite 240, San Diego, CA, 92121, US

(21) Appl. No.: 10/041,887

(22) Filed: Jan. 7, 2002

(51) Int. Cl. G06F 17/60

(52) U.S. Cl. 705/14

(57) ABSTRACT

A web-based method and system for increasing the effectiveness of a fundraising campaign is disclosed. In one embodiment, the method allows NPOs to cooperate with corporations to provide the incentives to the fundraisers. The method comprises the steps of contacting corporations to participate in a fundraising campaign by providing e-coupons, the e-coupons providing discounts for online shopping, receiving the e-coupons, creating one or more virtual goodie bags containing the e-coupons, contacting friends, family and others via emails to solicit donations, and providing the virtual goodie bags to the fundraisers. In one embodiment, the e-coupons are received and processed online. In one embodiment, the web-based system for increasing the effectiveness of a fundraising campaign by providing incentives to fundraisers comprises means for contacting corporations to participate in a fundraising campaign by providing e-coupons, means for receiving the e-coupons, one or more virtual goodie bags containing the e-coupons, email means for contacting friends, family and others to solicit donations, and means for providing the virtual goodie bags to the fundraisers.

### BACKGROUND

1. Field of Invention

The present invention relates to a method and system that increases the effectiveness of a fundraising campaign by providing incentives to fundraisers. The incentives encourage the fundraisers to increase their efforts to raise money online.

2. Description of Prior Art

Non-profit, charitable, philanthropic, social, political or other organizations (hereinafter generally referred to as NPOs) often raise money through donations. The NPOs typically raise money by one or more fundraising methods that include mail campaigns, telephone calls and other events. Recent growth of the Internet has caused the NPOs to also rely on the Internet for fundraising. Today the NPOs are relying on the Internet to reach out to potential donors. The NPOs have recognized the power of the Internet and are now actively seeking to raise money online. The NPOs often conduct fundraising campaigns or fundraising events to raise money. Volunteer fundraisers or other volunteers (hereinafter referred to as fundraisers) are typically enlisted for the campaigns to solicit donations on behalf of the NPOs. The fundraisers typically volunteer their time and effort for the benefit of the NPOs. In order to have a successful fundraising campaign, it is important that the fundraisers are adequately motivated and they are aware of the NPOs' missions and activities. The success of fundraising often depends on how vigorously the fundraisers solicit donations and their awareness of the NPOs' missions and activities. Enlistment of highly motivated fundraisers often results in greater success in fundraising. Conversely, a lack of motivation in the fundraisers makes it difficult for the NPOs to successfully raise money.

While fundraisers typically volunteer their time and effort and do not expect any compensation, it would be desirable if a method can be devised by which they are rewarded for their effort. It would be desirable if the NPOs could reward the fundraisers in some ways and show their appreciation to the volunteers.

Since the NPOs are engaged in charitable and philanthropic activities that benefit the society, they generally have a great amount of goodwill among the public. Thus, while the NPOs may not have great financial resources, their goodwill is a valuable asset. Corporations and other businesses that have adequate financial resources, on the other hand, often spend money in advertisements in an effort to increase their name recognition and profile. Thus, the NPOs and the corporations can benefit by cooperating with each other by utilizing each other's resources. In particular, the corporations can tap into the NPO's goodwill while the NPOs can use corporate resources to reward fundraisers and to increase public awareness.

Currently there are no efficient schemes that allow NPOs and corporations to cooperate in order to motivate fundraisers, increase corporate name recognition and profile and increase public awareness of the NPOs' missions and activities.

Accordingly, there is need for a method and system that allows the NPOs and the corporations to cooperate for their mutual benefit. More specifically, what is needed is a method and system that allows the NPOs to reward and motivate fundraisers using corporate resources that also increase corporate name recognition and profile. Such a scheme will allow the NPOs to raise more money by having motivated fundraisers and volunteers, and at the same time allow the corporations to tap into the goodwill associated with the NPOs and increase corporate name recognition and profile.

### SUMMARY OF THE INVENTION

The invention is directed to a web-based method and system for increasing the effectiveness of a fundraising campaign. The invention provides incentives to fundraisers and thereby motivating them to enthusiastically raise money on the Internet.

In one embodiment, the method allows NPOs to cooperate with corporations to provide the incentives to the fundraisers. The method comprises the steps of contacting corporations to participate in a fundraising campaign by providing e-coupons, the e-coupons providing discounts for online shopping, receiving the e-coupons, creating one or more virtual goodie bags containing the e-coupons, contacting friends, family and others via emails to solicit donations, and providing the virtual goodie bags to the fundraisers. In one embodiment, the e-coupons are received and processed online.

The method further comprises the step of purchasing merchandise online and using the e-coupons to obtain discounts on the merchandise. The method further comprises the step of creating one or more reports of the fundraising campaign. The report includes the amount of money raised in the campaign, the fundraisers engaged in the fundraising campaign, information about the donors and the corporations. In one embodiment, the emails include a link to a personal donation page. The emails include information about the fundraising campaign. In one embodiment, the method further comprises the step of acknowledging the corporations, the fundraisers and the donors on a virtual plaque.

In one embodiment, the web-based system for increasing the effectiveness of a fundraising campaign by providing incentives to fundraisers comprises means for contacting corporations to participate in a fundraising campaign by providing e-coupons, means for receiving the e-coupons, one or more virtual goodie bags containing the e-coupons, email means for contacting friends, family and others to solicit donations, means for receiving donations online, and means for providing the virtual goodie bags to the fundraisers.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 is a block diagram of one embodiment of the present invention in association with a wide area network;

FIG. 2 illustrates a system-level block diagram of one embodiment of the invention.

FIG. 3 is a flow diagram of the method steps in accordance with one embodiment of the invention.

FIGS. 4-12 are exemplary web pages that illustrate the operations and transactions in accordance with one embodiment of the invention.

### DETAILED DESCRIPTION OF THE INVENTION

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

It should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention provides a solution to the above-mentioned problems associated with existing fundraising schemes. In one aspect, the invention allows NPOs to increase the effectiveness of their fundraising campaigns by allowing corporations to participate in the fundraising campaigns and by providing incentives to fundraisers. The incentives encourage the fundraisers to increase their efforts to raise money online.

In one embodiment, the corporations provide online discount coupons (hereinafter referred to as “e-coupons”) that enable fundraisers to obtain discounts when they shop online. In other embodiments, the corporations and other sponsors provide cash or other valuables to the fundraisers.

In exchange for providing the incentives, the corporations receive increased name recognition by associating themselves with charitable causes. The corporations also benefit from increased traffic to their websites and from increased sales of products and services.

The invention benefits the NPOs by increasing the amount of money raised online. As participants increase their effort and more vigorously solicit donations online, the NPOs benefit by receiving increased donations.

The present invention can be conveniently implemented using one or more computer systems linked to a wide area network such as the Internet. In particular, the invention utilizes one or more web pages for a substantial part of its transactions.

In one embodiment, the invention comprises a database system that allows the NPOs to contact the corporations for e-coupons. The corporations are contacted via emails and are asked to provide e-coupons. The e-coupons are emailed back to the NPOs. In another embodiment, the corporations email “authorizations” (or permissions) to the database system. The “authorizations” are then used to obtain discounts on shopping. The corporations may also provide cash or other incentives.

The database allows the NPOs to receive the e-coupons and create one or more web pages containing the e-coupons. The web pages containing e-coupons are referred hereinafter as “goodie bags.” Thus, the database allows the NPOs to contact corporations via emails for the e-coupons, receive the e-coupons, and the create web pages containing the e-coupons. It should be understood that the invention may be utilized by any agents, organizations or other entities authorized by the NPOs. For example, an NPO may employ or authorize another organization to manage a fundraising campaign on behalf of the NPO. In that case, the agent can utilize the invention in the fundraising campaign.

The database further allows the NPOs to enlist fundraisers and other volunteers to register online to raise money on behalf of the NPOs. The fundraisers, donors or prospects are contacted via emails and are asked to volunteer in a fundraising campaign to benefit the NPOs. The fundraisers, donor or prospects register online and solicit donations online from friends, family and others.

The database allows the fundraisers to create their own personal web page or web site. The personal web pages include information about the fundraisers, the NPOs and the fundraising campaign. Also, the personal web pages can include information about the fundraiser's goals, the amount of money raised, or any other information.

The invention allows the fundraisers to efficiently reach out to potential donors via emails and solicit donations. A method and system for efficiently soliciting donations online is described in further detail in a pending patent application titled “METHOD AND SYSTEM FOR AN EFFICIENT FUNDRAISING CAMPAIGN OVER A WIDE AREA NETWORK”, application Ser. No. 09/764,787, filed Jan. 17, 2001, which is incorporated herein by reference in its entirety. The invention allows the fundraisers to include their personalized web page or a link to their web page in the email. The personalized web page and the email message provide potential donors information about the NPOs and the fundraising campaign.

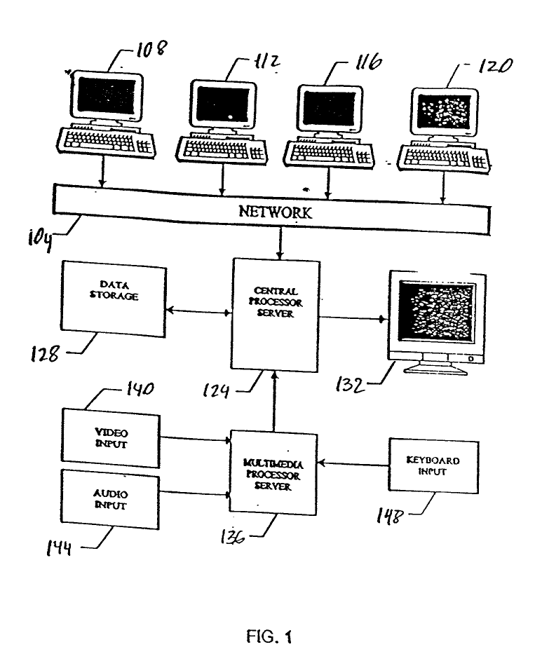

Referring now in more detail to the drawings, FIG. 1 is a block diagram of the present invention in association with a wide-area network. In FIG. 1, a wide-area network (e.g., the Internet) 104 is shown in conjunction with a number of representative user stations 108, 112, 116, and 120. It is well known in the art how to structure such wide-area network connections to provide two-way communication between various stations and locations connected to the network. In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations. The present invention can be implemented over the wide area network 104, such as the Internet, using one or more web pages and one or more databases linked to the network 104.

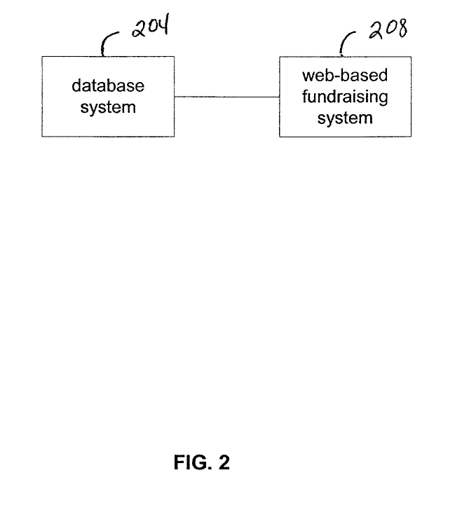

FIG. 2 illustrates a system-level block diagram of one embodiment of the invention. The invention includes a database 204 and a web-based fundraising system 208.

As noted before, the database 204 allows the NPOs to contact the corporations to participate in a fundraising campaign. The corporations are contacted by email and are asked to provide e-coupons. The e-coupons are provided to the fundraisers as incentives.

If a corporation wants to participate in the fundraising campaign, it can respond via email and send the e-coupons. The e-coupons are typically emailed directly to the charities, the organizers or any designated agents of the NPOs. In another embodiment, the participating corporations can send authorizations or permissions that can be used for discounts. The authorizations or permissions can be emailed or sent via other means. The database 204 receives the e-coupons, and keeps track of the corporations that have been contacted and those that have responded. The database 204 also produces one or more reports of the progress of the campaign. The database 204 retains additional information such as instructions for redeeming the e-coupons.

The database 204 also allows the NPOs or their agents to contact and enlist the fundraisers. The fundraisers agree to volunteer and raise money online. The database 204 keeps track of the fundraisers that have been contacted and those that have agreed to volunteer in the campaign.

The web-based fundraising system 208 allows efficient online fundraising on the Internet. The fundraising system 208 allows the fundraisers to create a personal donation page. The personal donation page provides information to potential donors and educates potential donors about the fundraising campaign. The personal donation page, for example, includes information about the NPOs and their activities. The personal donation page can also include information about the amount of money needed to be raised, the amount so far raised by the participant, the goal of the participant, and any other information.

The fundraising system 208 allows the fundraisers to contact friends, family and others via email and solicit donation for the benefit of the NPO. The fundraisers can include a personal message in their email and solicit potential donors to make a donation to a charitable cause. The email can incorporate their personal donation page or can include a link to their personal donation page.

In one embodiment, donors can make a donation online using a credit card or any other bank card. Also, donors can make donations offline using any other form of payment.

The database 204 keeps track of the progress of the fundraising campaign. In one embodiment, the database 204 keeps track of the amount of money raised, information about the donors, the fundraisers, and the amount of money raised by the fundraisers, etc.

In one embodiment, the invention includes one or more virtual plaques that acknowledge the donors, fundraisers, corporations and other participants. The virtual plaques can include information about the donors, the amount of donation or any other information. In one embodiment, the virtual plaque acknowledges the top fundraisers and the top donors. The virtual plaques are described in further detail in a pending patent application titled, “SYSTEM AND METHOD FOR INTERACTIVE FUNDRAISING OVER A WIDE AREA NETWORK”, application Ser. No. 09/740,761, filed Dec. 12, 2000, which is incorporated herein by reference in its entirety.

In one embodiment, the NPOs email the e-coupons to the fundraisers. The fundraisers can redeem the e-coupons by shopping online. The e-coupons provide discounts on various merchandise available for purchase online. In one embodiment, the e-coupons are provided to the fundraisers if they send emails to their friends and acquaintances. In other words, fundraisers do not necessarily have to be successful in raising money; so long as they make some effort to solicit donations online, they will be rewarded with the e-coupons. The e-coupons can provide a percent discount on merchandize, a fixed dollar amount discount or other gifts and prizes.

In one embodiment, the fundraisers click on the e-coupons and are directed to a website. The website typically is an online store that allows consumers to purchase various merchandize. The fundraisers select the merchandize they wish to purchase and redeem the e-coupons at the time of checkout. The e-coupons provide an incentive to the fundraisers to raise money online more vigorously. The corporations receive increased traffic into their websites as fundraisers go online to shop, thereby resulting in increased sales of merchandise.

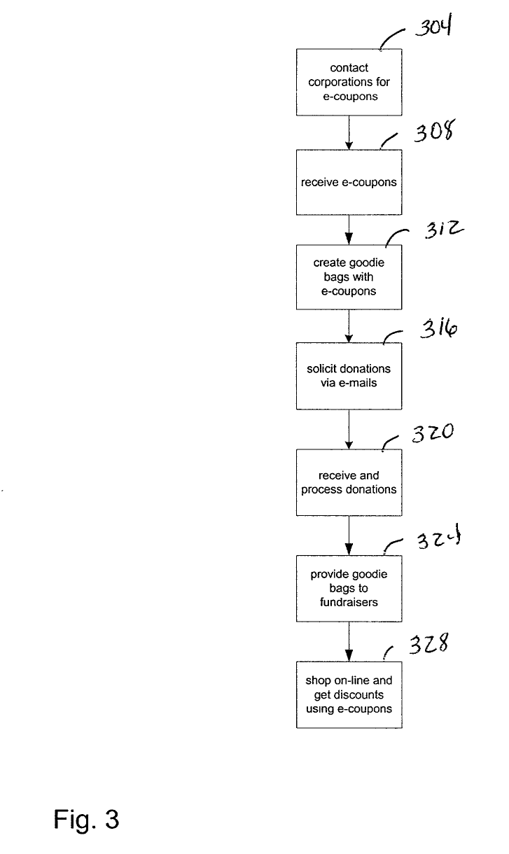

FIG. 3 is a flow diagram of the method steps of one embodiment of the invention. The flow begins in step 304 where the NPO contacts corporations to participate in a fundraising campaign. The corporations are requested to provide e-coupons that will be used as incentives to fundraisers and other volunteers. In exchange for providing the e-coupons, the corporations receive name recognition and can be acknowledged in various websites associated with the fundraising campaign. The corporations can also be acknowledged on virtual plaques, in emails or in print and other advertisements.

In step 308, the e-coupons are received online. In step 312, a virtual goodie bag is created containing the e-coupons. In one embodiment, the virtual goodie bag is a web page that includes the e-coupons. The virtual goodie bags are provided as incentives to the fundraisers that raise money online.

TABLE I

| Party | Obligations | Benefits |
|---|---|---|
| Corporations | Donate e-coupons | Receive recognition; increased |
| | | traffic to web sites |
| NPOs | Enlist fundraisers; provide | Motivated fundraisers; |
| | e-coupons to fundraisers | increased donations |
| Fundraisers | Raise money online | Receive discounts on |
| | | merchandize; receive |
| | | recognition and satisfaction |
| | | from helping NPOs |
| Donors | Donate money | Receive recognition and |
| | | satisfaction |

Table I lists the participants, their duties, obligations and benefits in a fundraising campaign implemented in accordance with the invention. In one aspect of the invention, four main participants to cooperate with each other in a campaign. These participants are:

(1) corporations;

(2) NPOs;

(3) fundraisers; and

(4) donors.

Referring again to Table I, the corporations provide e-coupons in order to participate in a fundraising campaign. The e-coupons are sent via emails and are used during online shopping. In exchange, the corporations receive name recognition and are acknowledged for associating with a charitable cause. The corporations also get increased traffic into their website and increased sales of their products and services.

Referring again to Table I, the NPOs enlist fundraisers to raise money online. The NPOs provide the e-coupons to the fundraisers as incentives. The NPOs benefit from having motivated fundraisers, resulting in increased donations.

Referring again to Table I, the fundraisers donate their time and effort to raise money online. The fundraisers obtain satisfaction by helping a charitable cause. The fundraisers further benefit by receiving e-coupons. In one embodiment, the fundraisers are acknowledged on virtual plaques on the websites.

Referring again to Table I, the donors make charitable donations that benefit a worthy cause. In one embodiment, the donors are acknowledged on a virtual plaque.

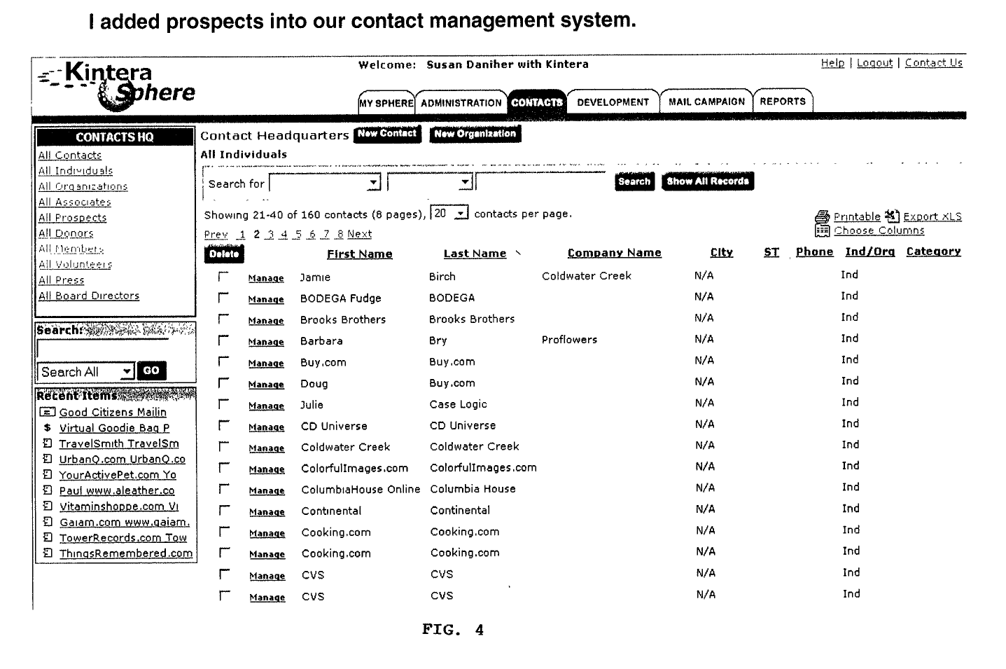

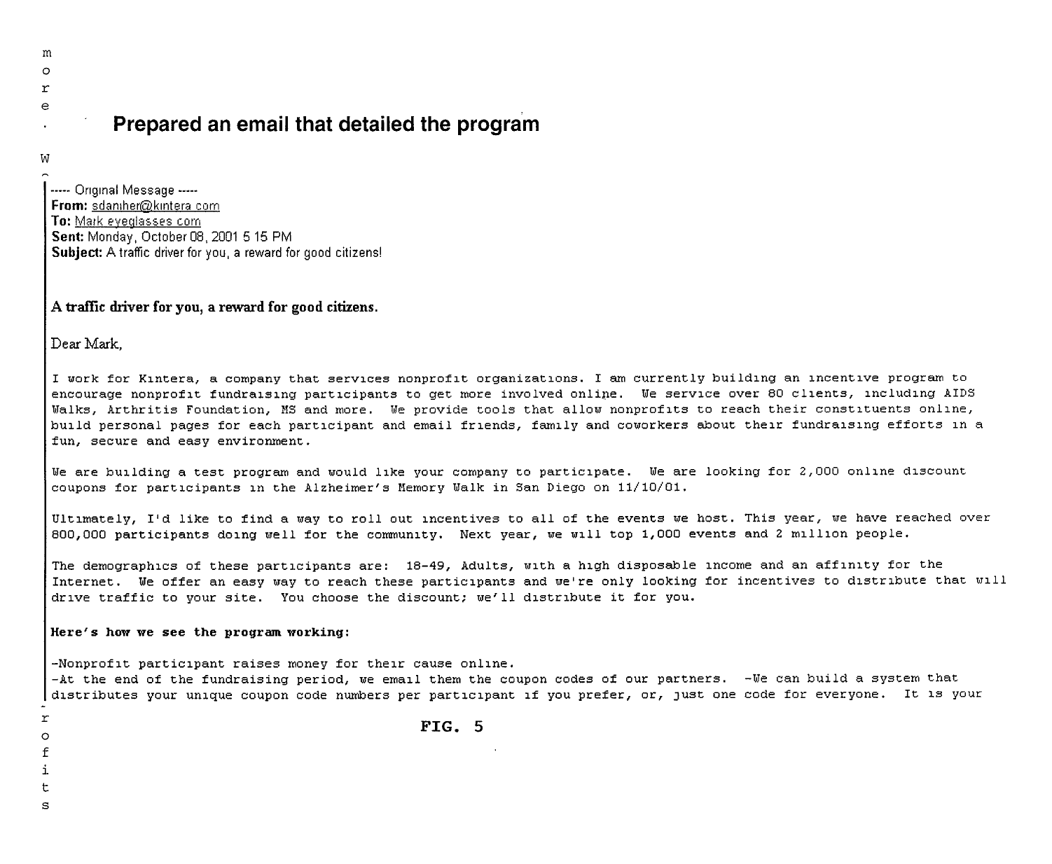

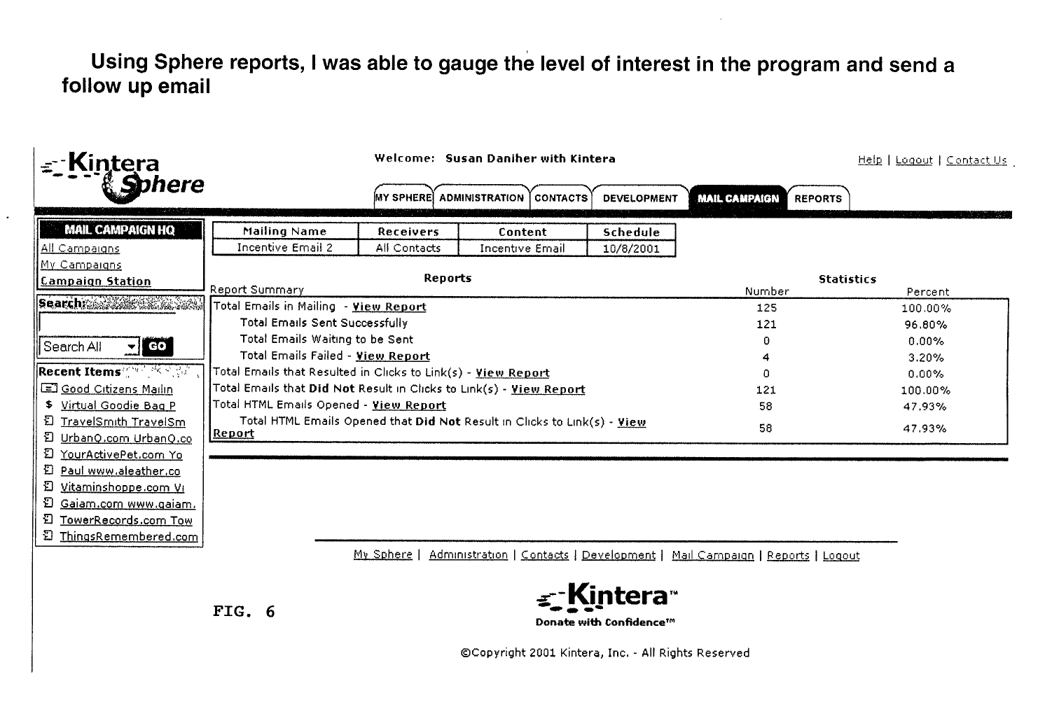

As noted before, the invention is implemented with one or more computer systems linked to a wide area network, such as the Internet. As noted before, the invention utilizes one or more web pages, and transactions are conveniently carried out online using one or more web pages. FIGS. 4-12 are exemplary web pages that further illustrate the operations and the transactions in accordance with one embodiment of the invention. FIG. 4 is a web page that lists various corporations contacted for e-coupons. FIG. 5 is a web page that illustrates an email sent to a corporation inviting it to participate in a fundraising campaign by providing e-coupons. FIG. 6 is a web page that shows the level of interest in the program.

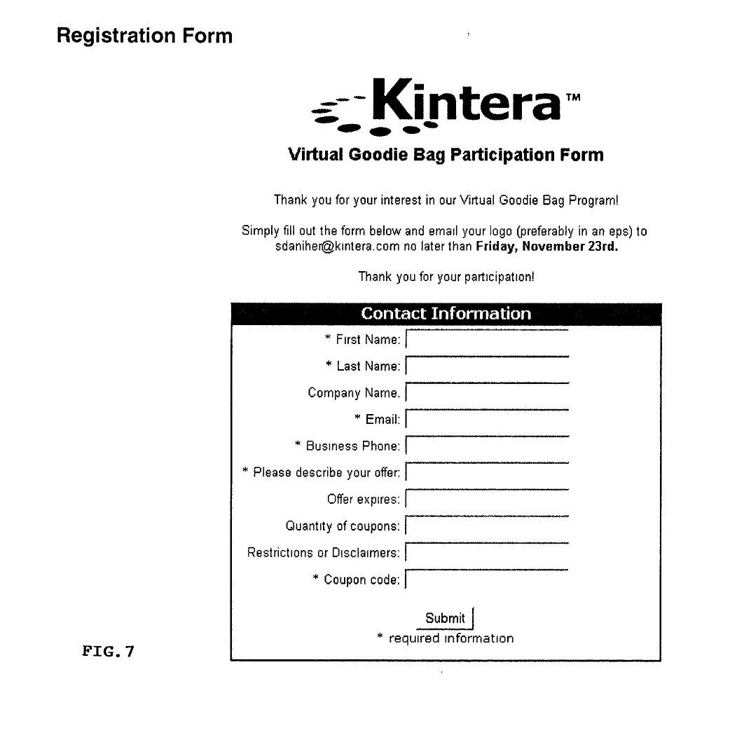

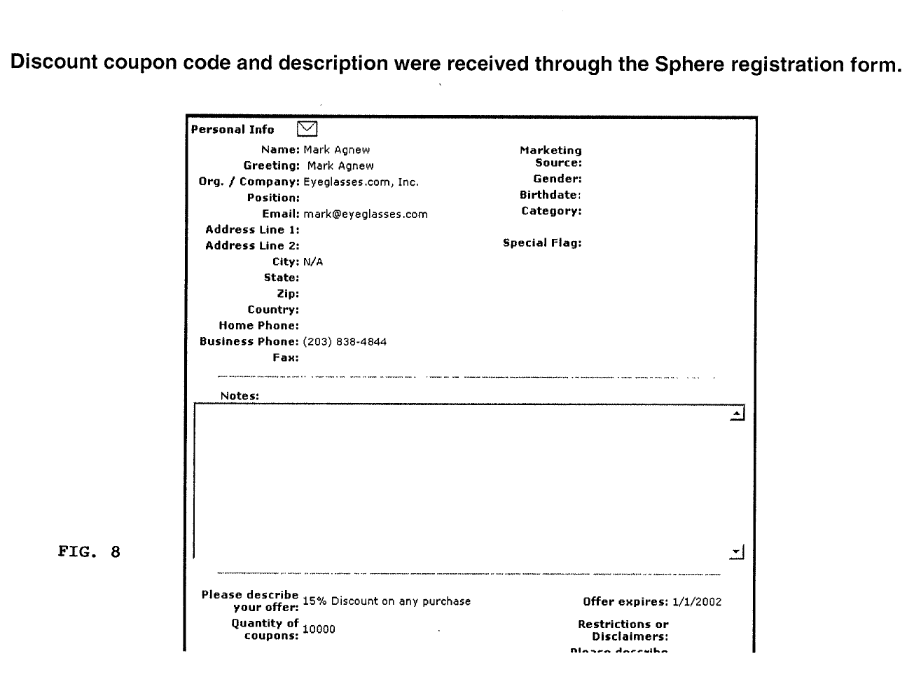

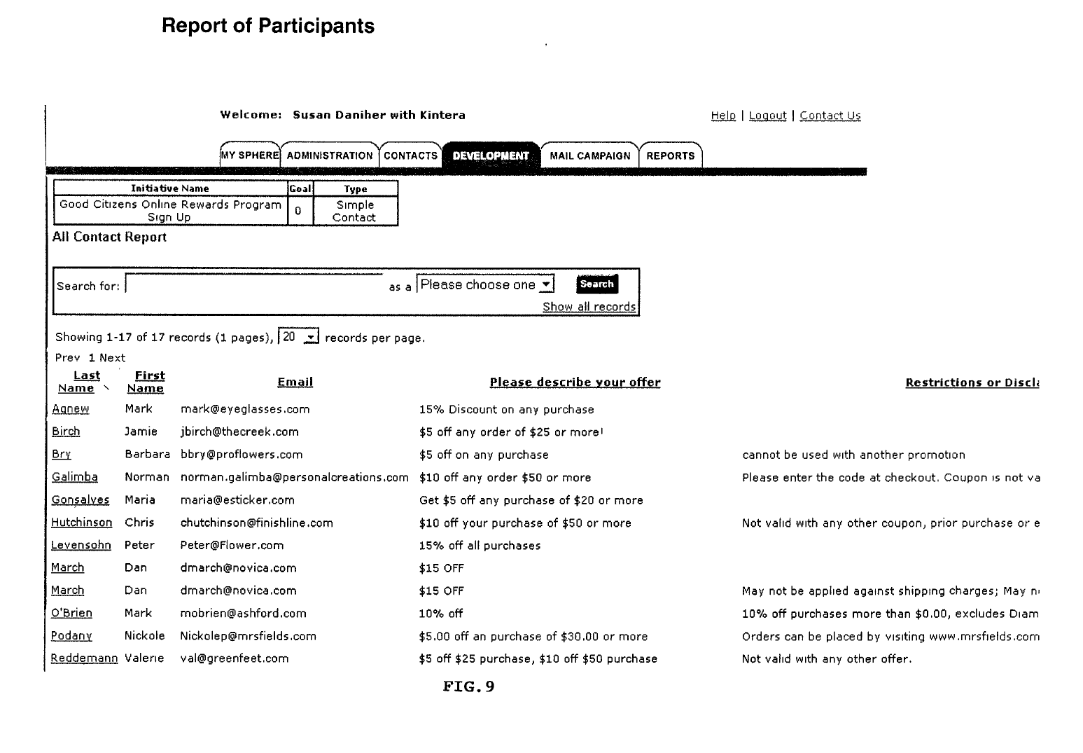

FIG. 7 is a web page that shows a registration form used by corporations to sign-up for the fundraising campaign and also to provide e-coupons. FIG. 8 is a web page that illustrates how e-coupons are received. FIG. 9 is a web page that lists corporations participating in the fundraising campaign and also includes information about the e-coupons.

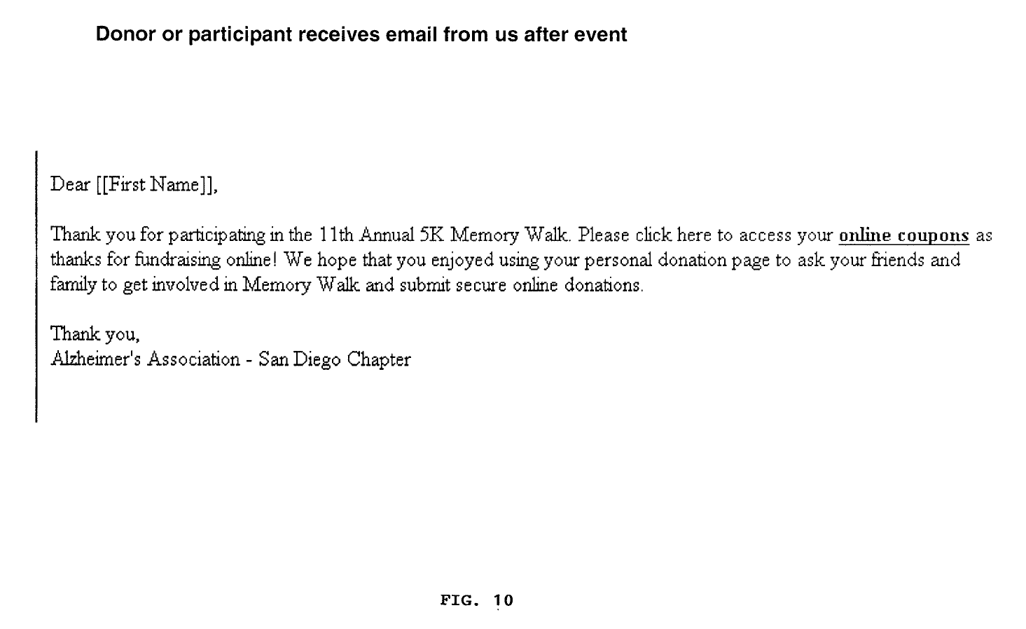

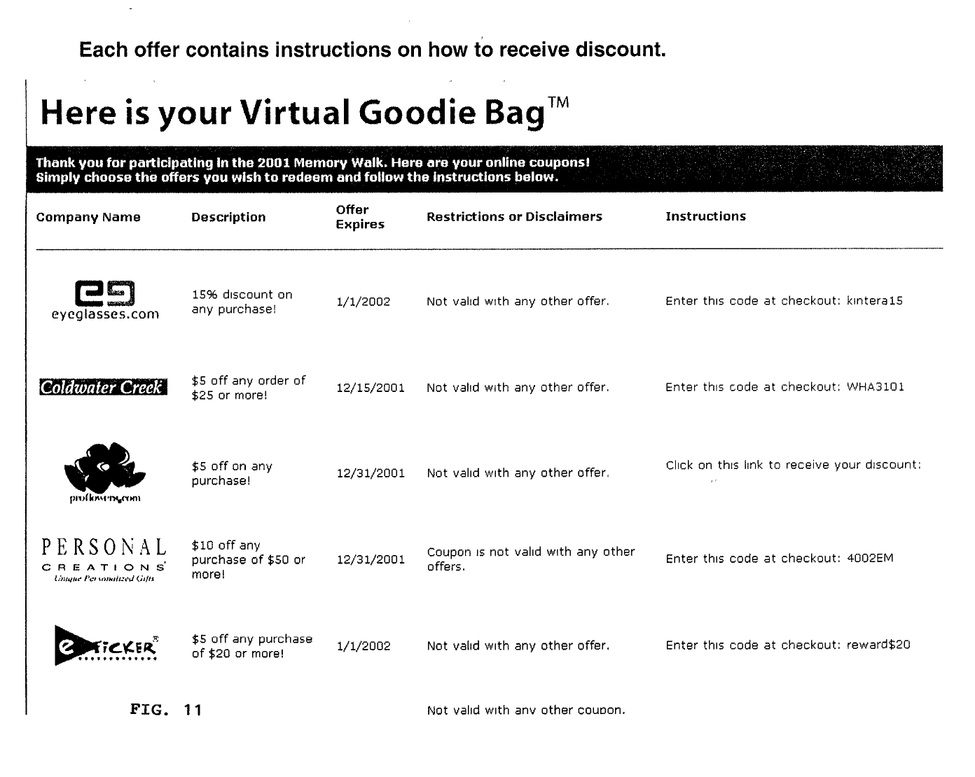

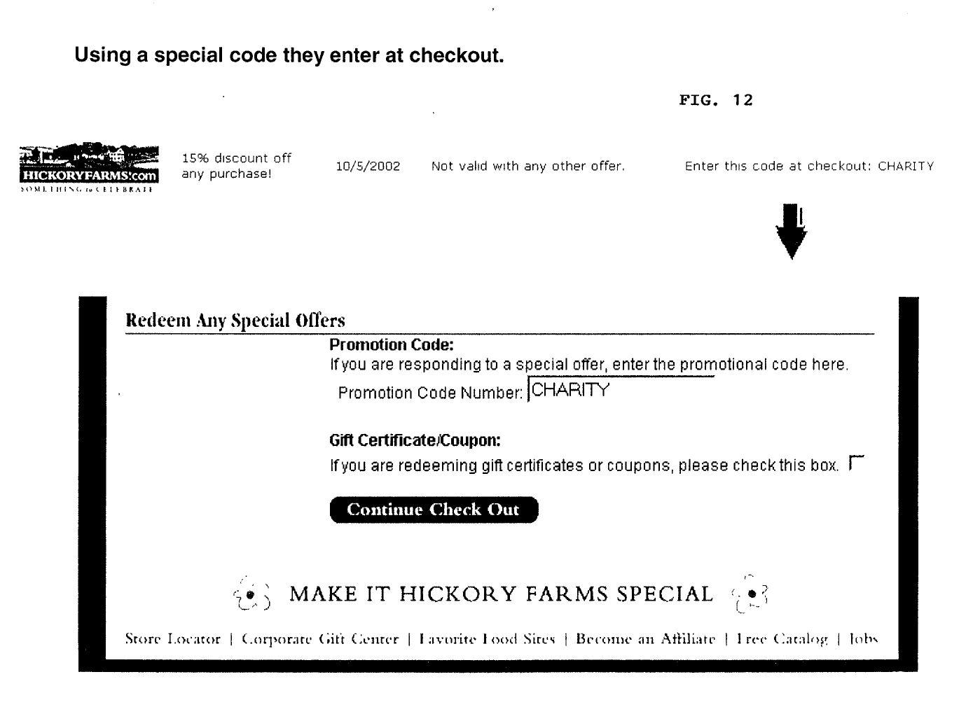

FIG. 10 is a web page containing an email thanking a fundraiser for participating in a fundraising campaign and also providing a link to e-coupons. When the fundraiser clicks onto the link, the fundraiser is directed to a goodie bag that contains e-coupons. FIG. 11 is a web page illustrating a goodie bag. FIGS. 12 and 13 shows two methods by which fundraisers can use the e-coupons.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that individuals and business entities may purchase or otherwise obtain the software program to set up an automated, on-line system.

Although the preferred embodiments have been described, it should be understood that various changes, substitutions, and alterations can be made herein without departing from the scope of the present invention. It should be noted that the present invention can be implemented using virtually any computer system or other networking system and virtually any available programming language. Thus the implementation of the present invention is not limited to the computer network illustrated in this document. Other examples of changes, substitutions, and alterations are readily ascertainable by one skilled in the art and could be made without departing from the spirit and scope of the present invention as defined by the following claims.

What is claimed is:

1. A web-based method for increasing the effectiveness of a fundraising campaign by providing incentives to fundraisers and thereby motivating them to enthusiastically raise money on the Internet, the method allowing NPOs to cooperate with corporations to provide the incentives to the fundraisers, the method comprising:
contacting corporations to participate in a fundraising campaign by providing e-coupons, the e-coupons providing discounts for online shopping;
receiving the e-coupons;
creating one or more virtual goodie bags containing the e-coupons;
contacting friends, family and others to solicit donations; and
providing the virtual goodie bags to the fundraisers.

2. The method according to claim 1, further comprising the step of purchasing merchandise online and using the e-coupons to obtain discounts on the merchandize.

3. The method according to claim 1, wherein the friends, family and others are contacted via emails.

4. The method according to claim 1, further comprising the step of creating one or more reports of the fundraising campaign.

5. The method according to claim 4, wherein the report includes the amount of money raised in the campaign.

6. The method according to claim 4, wherein the report includes the fundraisers engaged in the fundraising campaign.

7. The method according to claim 4, wherein the report includes information about the donors.

8. The method according to claim 4, wherein the report includes information about the corporations participating in the campaign.

9. The method according to claim 1, wherein the virtual goodie bag is a web page that includes the e-coupons.

10. The method according to claim 1, wherein the emails include a link to a personal donation page.

11. The method according to claim 1, wherein the email includes information about the fundraising campaign.

12. The method according to claim 1, wherein the email includes information about the fundraisers.

13. The method according to claim 1, further comprising acknowledging the corporations on a virtual plaque.

14. The method according to claim 1, further comprising acknowledging the fundraisers on a virtual plaque.

15. The method according to claim 1, further comprising acknowledging the donors on a virtual plaque.

16. A web-based system for increasing the effectiveness of a fundraising campaign by providing incentives to fundraisers and thereby motivating them to enthusiastically raise money on the Internet, the system allowing NPOs to cooperate with corporations to provide the incentives to the fundraisers, the system comprising:
means for contacting corporations to participate in a fundraising campaign by providing e-coupons;
means for receiving the e-coupons;
one or more virtual goodie bags containing the e-coupons;
email means for contacting friends, family and others to solicit donations; and
means for providing the virtual goodie bags to the fundraisers.

17. The system according to claim 15, further comprising one or more reports of the fundraising campaign.

18. The system according to claim 16, wherein the report includes the amount of money raised in the campaign.

19. The system according to claim 16, wherein the report includes the fundraisers engaged in the fundraising campaign.

20. The method according to claim 16, wherein the report includes information about the donors.

21. A computer program product including a program code embodied in a storage medium for carrying out a web-based method for increasing the effectiveness of a fundraising campaign by providing incentives to fundraisers and thereby motivating them to enthusiastically raise money on the Internet, the method allowing NPOs to cooperate with corporations to provide the incentives to the fundraisers, the method comprising:
contacting corporations to participate in a fundraising campaign by providing e-coupons, the e-coupons providing discounts for online shopping;
receiving the e-coupons;
creating one or more virtual goodie bags containing the e-coupons;
contacting friends, family and others to solicit donations; and
providing the virtual goodie bags to the fundraisers.

22. The method according to claim 1, further comprising the step of receiving donations online.

23. The method according to claim 1, wherein the e-coupons are received online.
